(19) United States
(12) Patent Application Publication
(10) Pub. No.: US 2025/0327949 A1
(43) Pub. Date: Oct. 23, 2025

(54) OPTICAL LENS

(71) Applicant: STANLEY ELECTRIC CO., LTD., Tokyo (JP)

(72) Inventors: Koji HORIBA, Tokyo (JP); Naoki YASUDA, Tokyo (JP); Ruri OI, Tokyo (JP); Riku TAKAHASHI, Tokyo (JP)

(21) Appl. No.: 19/172,030

(22) Filed: Apr. 7, 2025

(30) Foreign Application Priority Data
Apr. 17, 2024 (JP) 2024-066649

(51) Int. Cl. G02B 1/04; F21S 41/25

(52) U.S. Cl. CPC G02B 1/041; F21S 41/25

(57) ABSTRACT

One aspect of the presently disclosed subject matter is to provide an optical lens that makes it possible to suppress an occurrence of white turbidity and ensure light transmittance for a long period of time. There is provided an optical lens formed of a polycarbonate resin, in which a content of a compound having a hydroxy group derived from polycarbonate, which is contained in the polycarbonate resin, is 0.1 ppm or more and 200 ppm or less, and a spectral transmittance at a wavelength of 320 nm is 50% or more.

### CROSS-REFERENCE TO RELATED APPLICATION

Priority under 35 U.S.C. § 119 is claimed to Japanese Patent Application No. 2024-066649, filed Apr. 17, 2024, the content of which is incorporated herein by reference.

### BACKGROUND

### 1. Field

The presently disclosed subject matter relates to an optical lens.

### 2. Description of the Related Art

A polycarbonate resin (PC) which is a transparent synthetic resin is excellent in transparency, moldability, and mechanical properties. Therefore, it is used as a material for an optical lens in many fields such as a lens (cover) of a lamp for a vehicle such as an automobile, a motorcycle, or a bicycle, a lens of glasses, a cover of an optical sensor, and various liquid crystal panels. However, the optical lens formed of a polycarbonate resin has a problem in that it is difficult to ensure light transmittance for a long period of time due to an occurrence of white turbidity.

For example, Patent Literature 1 discloses a lens for a vehicle lamp, which is formed from a resin obtained by allowing an alicyclic structure-containing thermoplastic resin to contain a white turbidity preventing agent.

### CITATION LIST

### Patent Literature

[Patent Literature 1] Japanese Patent No. 4099870

### SUMMARY

### Problems to be Solved

However, even in a case where such a lens for a vehicle lamp is used, the fundamental cause of the occurrence of the white turbidity has not been solved, and there is a concern that the effect of the white turbidity preventing agent on the suppression of the occurrence of the white turbidity is insufficient, which makes it difficult to ensure the light transmittance of the lens for a long period of time.

The presently disclosed subject matter has been made in consideration of the above-described circumstances, and one aspect of the presently disclosed subject matter is to provide an optical lens that makes it possible to suppress the occurrence of white turbidity and ensure light transmittance for a long period of time.

### Means for Solving the Problems

An optical lens according to the presently disclosed subject matter is an optical lens formed of a polycarbonate resin, in which a content of a compound having a hydroxy group derived from polycarbonate, which is contained in the polycarbonate resin, is 0.1 ppm or more and 200 ppm or less, and a spectral transmittance at a wavelength of 320 nm is 50% or more.

### BRIEF DESCRIPTION OF THE DRAWINGS

FIG. 1 is a conceptual view illustrating an optical unit including an optical lens according to the presently disclosed subject matter.

FIG. 2 is a conceptual view illustrating an optical lens in the related art.

FIG. 3 is a table that summarizes configurations of examples and comparative examples of the optical lens (molded body) according to the presently disclosed subject matter.

FIG. 4 is a table that summarizes the comparative results of examples and comparative examples of the optical lens (molded body) according to the presently disclosed subject matter.

### DESCRIPTION OF EMBODIMENTS

Hereinafter, certain embodiments of the presently disclosed subject matter will be described; however, they may be appropriately modified and combined. In addition, in the following description and the attached drawings, substantially the same or equivalent portions will be described with the same reference numerals.

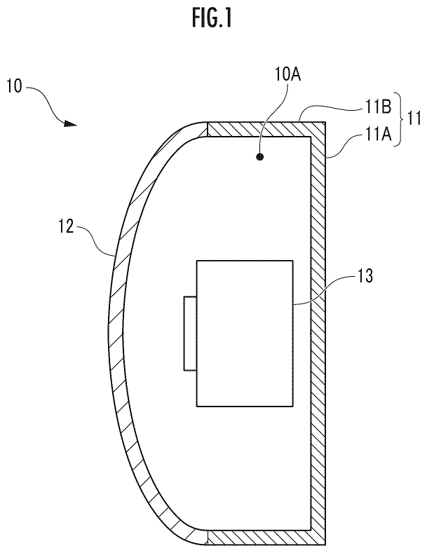

FIG. 1 is a conceptual view illustrating an optical unit 10 that uses an optical lens 12 according to the presently disclosed subject matter, which is a cross-sectional view of the optical unit 10. In the present embodiment, the optical unit 10 is a lamp unit for a vehicle, which has a light emitting device. That is, in the present embodiment, the optical lens 12 is a lens for a lamp for a vehicle. It is noted that the use application of the optical unit 10 is not limited to the headlight unit for a vehicle, and it may be used for a lamp for a vehicle such as an automobile or a motorcycle, an optical sensor, a street lamp, a camera, and the like other than the headlight.

As illustrated in FIG. 1, the optical unit 10 includes a housing 11, an optical lens 12 having light transmittance, and an optical instrument 13 configured to be disposed in an internal space 10A defined by the housing 11 and the optical lens 12.

The housing 11 is a housing that covers and supports a part of the optical instrument 13. Specifically, the housing 11 supports the optical instrument 13 through a fixing instrument (not illustrated in the drawing). The housing 11 has a lower wall 11A that covers a rear side of the optical instrument 13 and a first side wall 11B that extends in parallel with a light exit direction (left side direction in FIG. 1) of the optical instrument 13, and the front side thereof is opened.

As the housing 11, for example, a thermoplastic resin material having elasticity, such as an acrylonitrile butadiene styrene (ABS) resin, a polybutylene terephthalate (PBT) resin, or a polypropylene (PP) resin, is capable of being used.

The optical lens 12 is fixed to the housing 11 such that the optical lens 12 closes the opening of the housing 11. That is, the light emitted from the optical instrument 13 is transmitted through the optical lens 12 and is emitted to the outside of the internal space 10A.

A polycarbonate resin is used as a material of the optical lens 12. In addition, a content of a compound having a hydroxy group derived from polycarbonate, which is contained in the polycarbonate resin, is 0.1 ppm or more and 200 ppm or less.

The content of the compound having a hydroxy group derived from polycarbonate, which is contained in the polycarbonate resin, is capable of being measured, for example, by using a derivative formation method in a nuclear magnetic resonance (NMR) apparatus. Specifically, the content of the compound having a hydroxy group derived from polycarbonate is capable of being measured by subjecting the terminal of the hydroxy group of polycarbonate to trimethylsilylation and then quantifying the trimethylsilyl group by carrying out a comparison with an internal standard (ethyl acetate) with a nuclear magnetic resonance apparatus.

In the measurement for quantifying the trimethylsilyl group by carrying out a comparison with an internal standard (ethyl acetate) with a nuclear magnetic resonance apparatus, for example, the trimethylsilyl group is observed at s, 0.27 ppm, 9H after the induction of the trimethylsilyl group, and thus the quantification is capable of being carried out by comparing the integral ratio of ethyl acetate as an internal standard, at s, 2.0 ppm, 3H, by using an NMR measuring apparatus (apparatus name: AVACE NEO 400, manufactured by Bruker Japan Co., Ltd.).

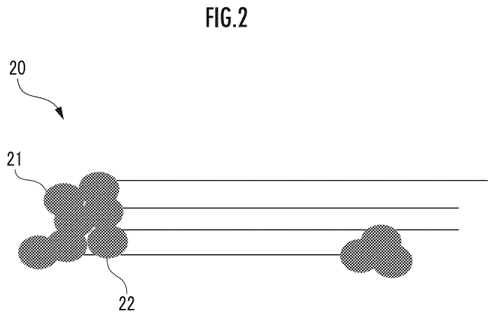

In the optical lens 20 in the related art, which has a large content of a compound having a hydroxy group derived from polycarbonate, which is contained in the polycarbonate resin, the compound having a hydroxy group 21 is aggregated by a hydrogen bond or the like and then formed into particles upon irradiation with light for a long period of time as illustrated in FIG. 2, thereby generating a fine particle aggregate 22 having an oxygen atom. Then, the light is scattered by the fine particle aggregate 22, and the optical lens has white turbidity.

On the other hand, since the compound having a hydroxy group derived from polycarbonate, which is contained in the polycarbonate resin used in the optical lens 12 according to the presently disclosed subject matter, is 200 ppm or less, the generation of fine particle aggregates generated upon irradiation with light for a long period of time is suppressed, which makes it possible to suppress the occurrence of white turbidity of the optical lens.

It is noted that the content of the compound having a hydroxy group derived from polycarbonate, which is contained in the polycarbonate resin, is preferably 0.5 ppm or more and 100 ppm or less.

As a result, the generation of fine particle aggregates is further suppressed, which makes it possible to further suppress the occurrence of white turbidity of the optical lens. That is, there is a positive correlation between the content of the compound having a hydroxy group derived from polycarbonate, which is contained in the polycarbonate resin, and the quantity of fine particle aggregates to be generated.

The compound having a hydroxy group derived from polycarbonate is represented by, for example, General Formulae (1) to (6).

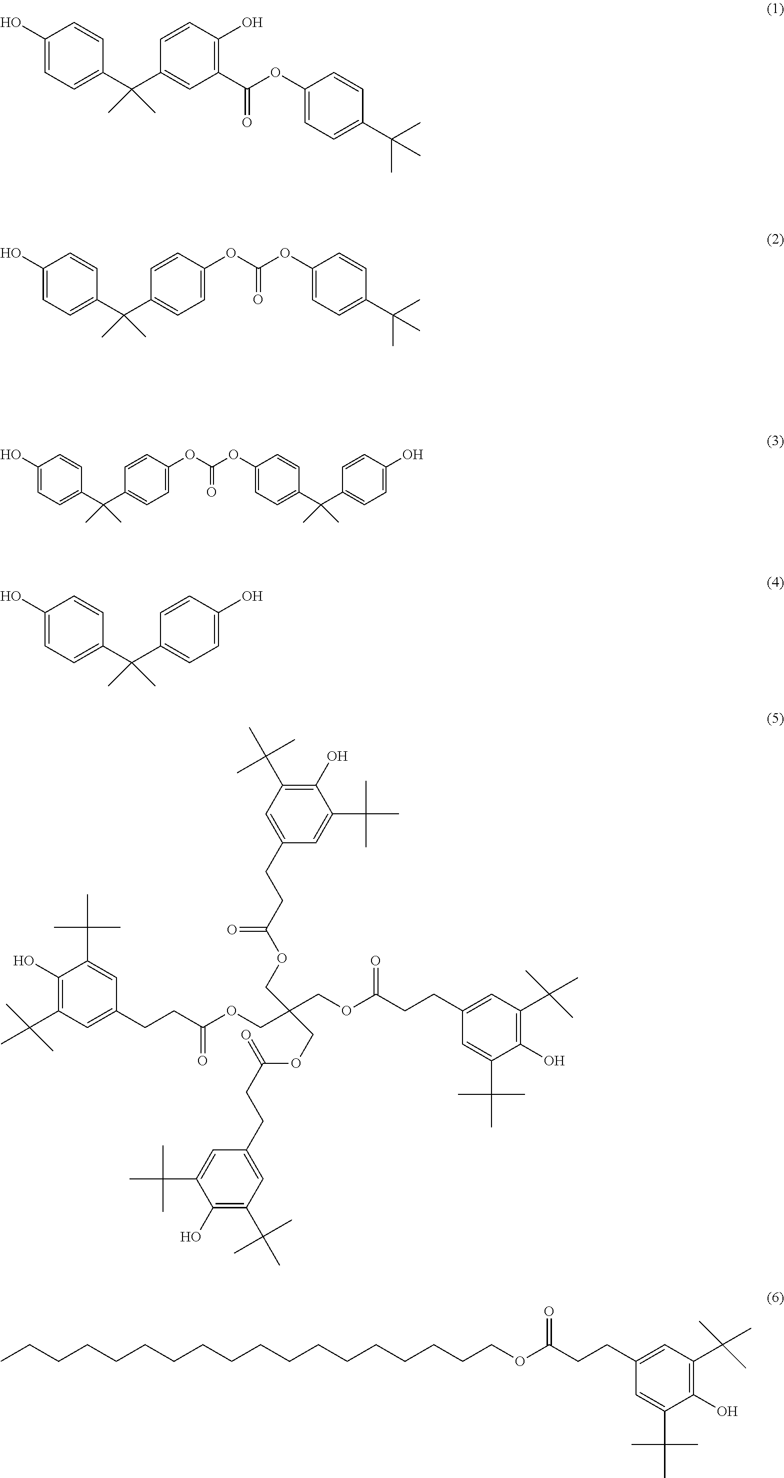

Among the compounds represented by General Formulae (1) to (6), particularly, the compounds represented by General Formulae (1) to (3) are aggregated by a hydrogen bond or the like and then formed into particles upon irradiation with light for a long period of time, thereby easily generating a fine particle aggregate having an oxygen atom. Therefore, the content of the compounds represented by General Formulae (1) to (3) is preferably 0.1 ppm or more and 200 ppm or less, and more preferably 0.5 ppm or more and 100 ppm or less.

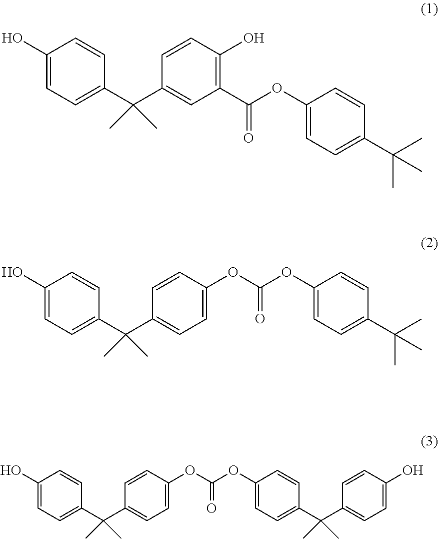

As a result, the generation of fine particle aggregates is further suppressed, which makes it possible to further suppress the occurrence of white turbidity of the optical lens.

In the optical lens 12, after turning on the optical instrument 13 for 1,000 hours, the number of fine particle aggregates which are observed to have a size of 100 nm or more and 5 μm or less in an image obtained by imaging a cross section of the optical lens 12 on an optical path in a thickness direction at a magnification of 1,000 times by using a scanning electron microscope (SEM) and are confirmed to have an oxygen atom by using energy dispersive X-ray spectrometry (EDS) is less than 10.

The fine particle aggregates are capable of being observed with a scanning electron microscope, for example, by continuously turning on a polycarbonate molded body with an LED white light source for 1,000 hours, subsequently cutting a portion having white turbidity into a slice having a thickness of 10 μm using an ultrasonic cutter and a microtome (manufactured by YAMATO KOHKI INDUSTRIAL Co., Ltd.), and carrying out checking under the following conditions.

### (Analysis Conditions)

Device name: JSM-IT700HR (manufactured by JEOL Ltd.)
Signal: SED
Incident voltage: 15.0 kV
WD: 10.0 mm
Magnification: ×1,000
Observation range: 128.0×96.0 μm
Irradiation current number: Srd. 75.0
Scan rotation: 0.0°
Vacuum mode: High Vacuum

The checking that the fine particle aggregate has an oxygen atom by energy dispersive X-ray spectrometry is capable of being carried out, for example, by continuously turning on a polycarbonate molded body with an LED white light source for 1,000 hours, and then cutting a portion having white turbidity into a slice having a thickness of 10 μm using an ultrasonic cutter and a microtome (manufactured by YAMATO KOHKI INDUSTRIAL Co., Ltd.), and carrying out checking under the following conditions.

### (Analysis Conditions)

Device name: JSM-IT700HR (manufactured by JEOL Ltd.)
Detector: EDS detector, dry SD detector
Device name: EX-7412U4L2Q
Method: Silicon drift type
Detection element area: 30 mm²
Energy resolution: 129 eV or less
Detectable elements: Be to U
Window: Polymer thin film
Cooling method: Electronic cooling (Peltier cooling)
Usable acceleration voltage: 30 kV or less
Digital processor
Maximum throughput: 200 kcps
Interface: RS-232C

Since the number of the fine particle aggregates confirmed by the above-described measuring method is less than 10 in the optical lens 12, light is scattered by the fine particle aggregates, which makes it possible to suppress the white turbidity of the optical lens 12.

It is noted that the quantity of fine particle aggregates that are observed and confirmed by the above-described measuring method in the optical lens 12 is preferably 5 or less and more preferably 2 or less. As a result, the light is scattered by the fine particle aggregate, which makes it possible to further suppress the white turbidity of the optical lens 12.

In the optical lens 12, the spectral transmittance (%) at a wavelength of 320 nm in the thickness direction is 50% or more. In the measurement of the spectral transmittance at a wavelength of 320 nm, the measurement is capable of being carried out, for example, by scanning a wavelength of 250 nm to 800 nm with a D2 light source and a W light source by using an ultraviolet-visible spectrophotometer (device name: UV-2600i, manufactured by Shimadzu Corporation).

It is noted that in the optical lens 12, the spectral transmittance (%) at a wavelength of 320 nm in the thickness direction is preferably 55% or more, more preferably 60% or more, and still more preferably 65% or more.

It is noted that, in a range in which the content of the polycarbonate resin used in the optical lens 12 is 95% or more, various additives such as an antioxidant, a plasticizer, an antistatic agent, a nucleating agent, a flame retardant, a lubricating agent, an impact modifier, a fluorescent whitening agent, and an ultraviolet absorbing agent may be added.

In the present embodiment, an LED light source is used as the optical instrument 13. It is noted that a lamp unit such as a fluorescent lamp, a laser beam source, or an incandescent bulb, or an optical sensor unit that emits visible light, infrared rays, ultraviolet rays, millimeter waves, or the like, or an optical sensor unit or the like, which detects visible light, infrared rays, ultraviolet rays, millimeter waves, or the like may be used as the optical instrument 13. In addition, an optical sensor unit that detects a light source of an optical sensor and reflected light of light emitted from the light source of the optical sensor may be used.

Next, a polycarbonate resin used in the optical lens 12 according to the presently disclosed subject matter and a manufacturing method for the optical lens 12 will be described.

The polycarbonate resin used in the optical lens 12 according to the presently disclosed subject matter is capable of being manufactured by subjecting a composition containing an aromatic diol compound and a carbonate precursor to interfacial polymerization in the presence of an acid binding agent and a solvent as shown in the chemical formula below (interfacial polymerization method).

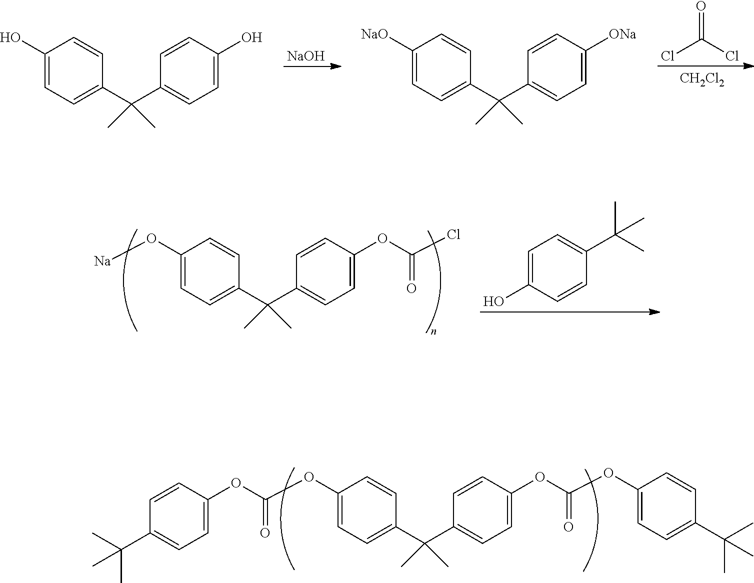

As shown in the above chemical formula, in the present embodiment, 2,2-bis(4-hydroxyphenyl)propane (bisphenol A) was used as the aromatic diol compound, phosgene was used as the carbonate precursor, sodium hydroxide was used as the acid binding agent, and dichloromethane was used as the solvent. In addition, 4-methylphenol was used as a terminator.

The content of the aromatic diol compound is capable of being set to 40 parts by mass or more and 80% by weight or less with respect to the total amount of the composition. In addition, the content of the carbonate precursor is capable of being set to 20% by weight or more and 60% by weight or less with respect to the total amount of the composition.

The interfacial polymerization of the composition was carried out in a nitrogen atmosphere (oxygen-free environment), and the interfacial polymerization was carried out under conditions of a polymerization temperature of 0° C. to 40° C. and a reaction time of several minutes to 5 hours. In addition, the pH during the reaction was maintained at 9 or more.

In the present embodiment, bisphenol A is used as the aromatic diol compound; however, as the aromatic diol compound, for example, the following compound may be used: 2,2-bis(4-hydroxyphenyl)butane, 2,2-bis(4-hydroxy-3,5-dibromophenyl)propane, 2,2-bis(4-hydroxy-3-chlorophenyl)propane, 2,2-bis(4-hydroxy-3-methylphenyl)propane, 2,2-bis(4-hydroxy-3,5-dimethylphenyl)propane, 1,1-bis(4-hydroxyphenyl)cyclohexane, 1,1-bis(4-hydroxyphenyl)ethane, bis(4-hydroxyphenyl)methane, bis(4-hydroxyphenyl)ether, bis(4-hydroxyphenyl)sulfone, bis(4-hydroxyphenyl)sulfoxide, bis(4-hydroxyphenyl)sulfide, bis(4-hydroxyphenyl)ketone, or the like. In addition, these aromatic diol compounds may be used alone, or any two or more kinds thereof may be used in combination.

In the present embodiment, phosgene is used as the carbonate precursor; however, as the carbonate precursor, for example, the following precursor may be used: triphosgene, diphosgene, bromophosgene, dimethyl carbonate, diethyl carbonate, dibutyl carbonate, dicyclohexyl carbonate, diphenyl carbonate, ditolyl carbonate, bis(chlorophenyl) carbonate, m-cresyl carbonate, dinaphthyl carbonate, bis(diphenyl) carbonate, bishaloformate, or the like.

In the present embodiment, sodium hydroxide is used as the acid binding agent; however, as the acid binding agent, for example, an alkali metal hydroxide such as potassium hydroxide or an amine compound such as pyridine may be used.

In the present embodiment, dichloromethane is used as the solvent; however, a halogenated hydrocarbon such as chlorobenzene may be used as the solvent.

In the present embodiment, 4-methylphenol is used as the terminator; however, for example, 3-methylphenol, phenol, 4-propylphenol, 3-propylphenol, 1-phenylphenol, 2-phenylphenol, or the like may be used as the terminator.

It is noted that a catalyst such as a tertiary amine or a quaternary ammonium salt may be added to the composition as an additive in order to promote the reaction.

In the above-described manufacturing method for a polycarbonate resin, the manufacturing method according to an interfacial polymerization method has been described; however, the polycarbonate resin may be manufactured by a melt polymerization method (an ester exchange method).

As an example of the method for manufacturing the optical lens 12 according to the presently disclosed subject matter from the polycarbonate resin, the optical lens 12 is capable of being manufactured by mixing polycarbonate and other additives using a mixer, subsequently subjecting the resultant mixture to extrusion molding with an extruder to manufacture pellets, drying the pellets, and then carrying out molding with an injection molding machine.

### EXAMPLES

Hereinafter, the presently disclosed subject matter will be described in more detail with reference to Examples and Comparative Examples. It is noted that the presently disclosed subject matter is not limited to these Examples. It is noted that the synthesis of the component was carried out based on technical literature (Molecules 2010, 15, 3661-3682, pp. 3664 and 3677).

### [Synthesis of Intermediate]

First, 20.0 g of bisphenol A (manufactured by FUJIFILM Wako Pure Chemical Corporation), 4.16 g of pyridine (manufactured by FUJIFILM Wako Pure Chemical Corporation), 0.16 g of 4-DMAP (manufactured by FUJIFILM Wako Pure Chemical Corporation), and 300 g of dry THF (manufactured by Junsei Chemical Co., Ltd.) were added to a 500 mL three-neck flask, and the resultant mixture was cooled to 0° C. and stirred. 4.14 g of methyl chloroformate (manufactured by Tokyo Chemical Industry Co., Ltd.) was added dropwise thereto gradually a little bit at a time over 30 minutes, and the resultant mixture was stirred at 0° C. for 1 hour and at 25° C. for 1 hour to carry out a reaction. After completion of the reaction, the reactant was poured into a 2,000 mL beaker (in 600 mL of pure water) to obtain a white precipitate. This white precipitate was recovered by suction filtration. Thereafter, the precipitate was washed three times with 300 ml of a 10% sodium carbonate aqueous solution and then washed with 300 ml of pure water. Vacuum drying was carried out at 40° C. for 15 hours to obtain 15 g of an intermediate.

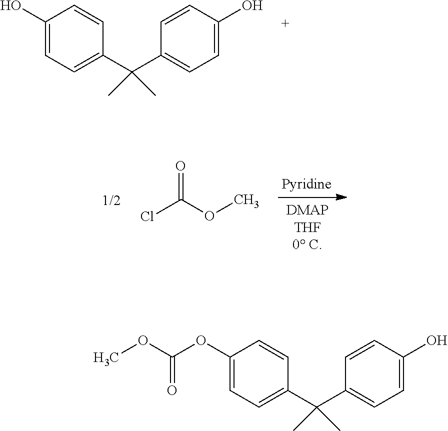

### Synthesis Example 1

10 g of the intermediate, 0.1 g of ORGATIX TC-400 (manufactured by Matsumoto Fine Chemical Co., Ltd.) as a catalyst, and 25.0 g of p-tert-butylphenol (manufactured by FUJIFILM Wako Pure Chemical Corporation) were added to a 200 mL three-neck flask, and the resultant mixture was refluxed at 120° C. for 3 hours. After the reaction, the disappearance of the peak of the methyl group of the intermediate was confirmed by NMR, and a crude product was obtained. Tert-butylphenol was distilled off by distilling, and then recrystallization was carried out with ethanol to obtain 5 g of a component of Synthesis Example 1.

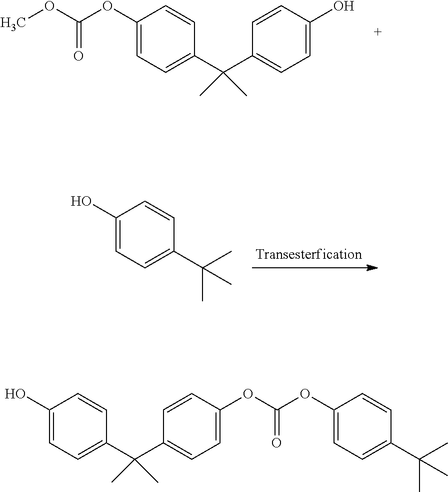 [SMILES: COC(=O)Oc1ccc(C(C)(C)c2ccc(O)cc2)cc1 ; CC(C)(C)c1ccc(O)cc1 ; CC(C)(C)c1ccc(OC(=O)Oc2ccc(C(C)(C)c3ccc(O)cc3)cc2)cc1]

### Synthesis Example 2

10 g of the intermediate, 0.1 g of ORGATIX TC-400 (manufactured by Matsumoto Fine Chemical Co., Ltd.) as a catalyst, and 25.0 g of bisphenol A (manufactured by FUJIFILM Wako Pure Chemical Corporation) were added to a 200 mL three-neck flask, and the resultant mixture was refluxed at 170° C. for 3 hours. After the reaction, the disappearance of the peak of the methyl group of the intermediate was confirmed by NMR, and a crude product was obtained. After washing bisphenol A with methanol to remove the bisphenol A, washing was repeatedly carried out with methanol to obtain 5 g of a component of Synthesis Example 2.

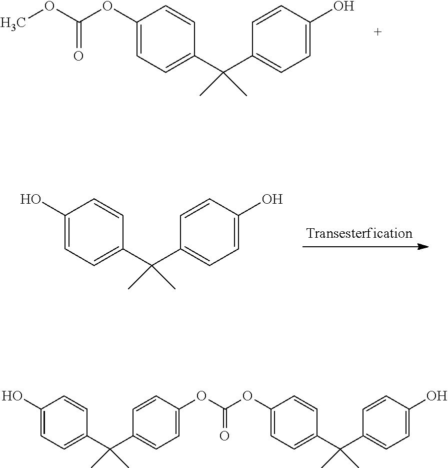 [SMILES: COC(=O)Oc1ccc(C(C)(C)c2ccc(O)cc2)cc1 ; CC(C)(c1ccc(O)cc1)c1ccc(O)cc1 ; CC(C)(c1ccc(O)cc1)c1ccc(OC(=O)Oc2ccc(C(C)(C)c3ccc(O)cc3)cc2)cc1]

### Synthesis Example 3

3 g of the components of Synthesis Example 1 and 5 g of aluminum chloride (manufactured by Tokyo Chemical Industry Co., Ltd.) were added to a 100 mL three-neck flask, and 50 mL of THF was added thereto. This was reacted at 60° C. for 5 hours to obtain a crude product. The obtained crude product was purified by silica gel chromatography (hexane/ethyl acetate) to obtain 1 g of a component of Synthesis Example 3.

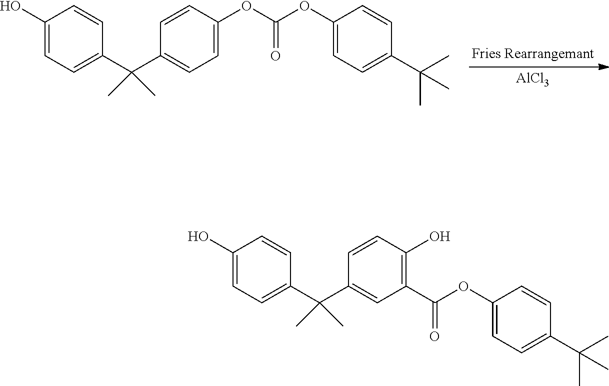

### Example 1

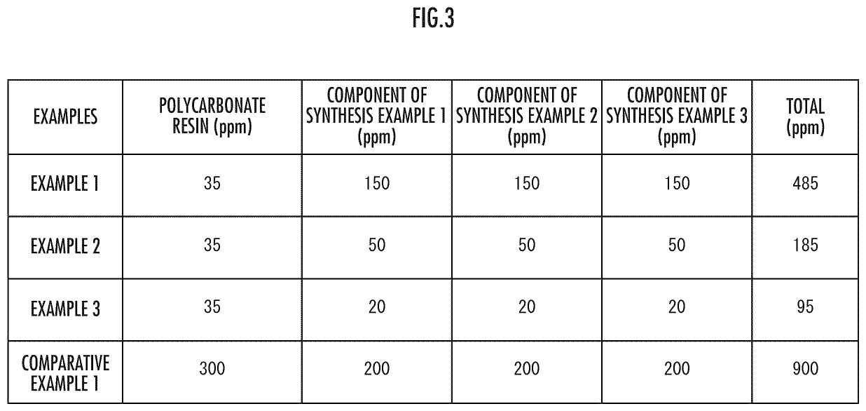

100 ppm of octadecyl 3-(3,5-di-tert-butyl-4-hydroxyphenyl) propanoate (product name: Irganox 1076, manufactured by BASF Japan Ltd.) as an antioxidant, 150 ppm of the component of Synthesis Example 1, 150 ppm of the component of Synthesis Example 2, and 150 ppm of the component of Synthesis Example 3 were added to polycarbonate resin pellets (product name: Iupilon ML-300, manufactured by Mitsubishi Engineering-Plastics Corporation), and the resultant mixture was molded with an injection molding machine to obtain a molded body (optical lens) of Example 1 having a thickness of 3 mm and a size of 100 mm×80 mm. The configurations of Examples 1 to 3 and Comparative Example 1 are collectively described in FIG. 3.

### Example 2

100 ppm of octadecyl 3-(3,5-di-tert-butyl-4-hydroxyphenyl) propanoate (product name: Irganox 1076, manufactured by BASF Japan Ltd.) as an antioxidant, 50 ppm of the component of Synthesis Example 1, 50 ppm of the component of Synthesis Example 2, and 50 ppm of the component of Synthesis Example 3 were added to polycarbonate resin pellets (product name: Iupilon ML-300, manufactured by Mitsubishi Engineering-Plastics Corporation), and the resultant mixture was molded with an injection molding machine to obtain a molded body (optical lens) of Example 2 having a thickness of 3 mm and a size of 100 mm×80 mm.

### Example 3

100 ppm of octadecyl 3-(3,5-di-tert-butyl-4-hydroxyphenyl) propanoate (product name: Irganox 1076, manufactured by BASF Japan Ltd.) as an antioxidant, 20 ppm of the component of Synthesis Example 1, 20 ppm of the component of Synthesis Example 2, and 20 ppm of the component of Synthesis Example 3 were added to polycarbonate resin pellets (product name: Iupilon ML-300, manufactured by Mitsubishi Engineering-Plastics Corporation), and the resultant mixture was molded with an injection molding machine to obtain a molded body (optical lens) of Example 3 having a thickness of 3 mm and a size of 100 mm×80 mm.

100 ppm of octadecyl 3-(3,5-di-tert-butyl-4-hydroxyphenyl) propanoate (product name: Irganox 1076, manufactured by BASF Japan Ltd.) as an antioxidant, 200 ppm of the component of Synthesis Example 1, 200 ppm of the component of Synthesis Example 2, and 200 ppm of the component of Synthesis Example 3 were added to polycarbonate resin pellets (product name: Makrolon 2205, manufactured by Covestro Japan Ltd.), and the resultant mixture was molded with an injection molding machine to obtain a molded body (optical lens) of Comparative Example 1 having a thickness of 3 mm and a size of 100 mm×80 mm.

### (Evaluation of Content of Hydroxy Group)

Each of the molded bodies of Examples 1 to 3 and the molded body of Comparative Example 1, and 2 mL of chloroform were placed in a 50 mL two-neck flask, and the resultant mixture was stirred with a stirrer for 1 hour to dissolve the molded bodies. 0.5 mL of hexamethyldisilazane and 0.2 mL of trimethylchlorosilane were added thereto, and the resultant mixture was reacted at 70° C. for 2 hours to induce a hydroxy group to a trimethylsilyl group. 0.28 ppm of the obtained derivative was quantified by being compared with 2.0 ppm of ethyl acetate in a deuterated chloroform solvent with a nuclear magnetic resonance apparatus, and the evaluation was carried out in five stages of A to E.

In the measurement for quantifying the trimethylsilyl group by carrying out a comparison with an internal standard (ethyl acetate) with a nuclear magnetic resonance apparatus, the trimethylsilyl group was observed at s, 0.27 ppm, 9H after the induction of the trimethylsilyl group, and thus the quantification could be carried out by comparing the integral ratio of ethyl acetate as an internal standard, at s, 2.0 ppm, 3H, by using an NMR measuring apparatus (apparatus name: AVACE NEO 400, manufactured by Bruker Japan Co., Ltd.).

It is noted that octadecyl 3-(3,5-di-tert-butyl-4-hydroxyphenyl) propanoate (product name: Irganox 1076, manufactured by BASF Japan Ltd.), which is an antioxidant having a hydroxy group, was not induced to form a derivative to have a trimethylsilyl group by a tert-butyl group adjacent to the ortho position, and then the quantification was carried out.

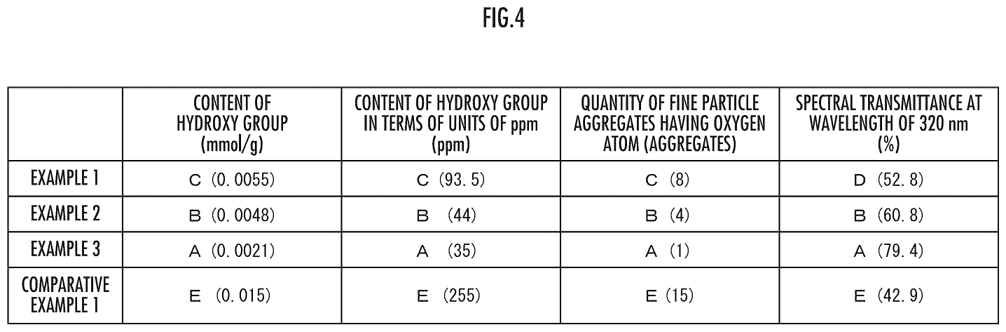

In the evaluation, a case where the content of the hydroxy group was 0.001 mmol/g or more and 0.003 mmol/g or less was evaluated as A, a case where the content of the hydroxy group was 0.003 mmol/g or more and less than 0.005 mmol/g was evaluated as B, a case where the content of the hydroxy group was 0.005 mmol/g or more and less than 0.008 mmol/g was evaluated as C, a case where the content of the hydroxy group was 0.008 mmol/g or more and less than 0.01 mmol/g was evaluated as D, and a case where the content of the hydroxy group was 0.01 mmol/g or more was evaluated as E. FIG. 4 summarizes the evaluation results of the content of the hydroxy group in Examples 1 to 3 and Comparative Example 1. It is noted that numerical values in parentheses shown in FIG. 4 are actually measured values.

### (Evaluation of Content of Hydroxy Group in Terms of Units of Ppm)

The quantitative value obtained in the evaluation of the content of the hydroxy group described above was multiplied by “the number of hydroxy groups×17” to derive the content of the hydroxy group in terms of units of ppm, and the evaluation was carried out in five stages of A to E. In the evaluation, a case where the content of the hydroxy group was 10 ppm or more and less than 40 ppm was evaluated as A, a case where the content of the hydroxy group was 40 ppm or more and less than 80 ppm was evaluated as B, a case where the content of the hydroxy group was 80 ppm or more and less than 120 ppm was evaluated as C, a case where the content of the hydroxy group was 120 ppm or more and less than 160 ppm was evaluated as D, and a case where the content of the hydroxy group was 160 ppm or more was evaluated as E. FIG. 4 summarizes the evaluation results of the content of the hydroxy group in Examples 1 to 3 and Comparative Example 1, in terms of units of ppm. It is noted that numerical values in parentheses shown in FIG. 4 are actually measured values.

### (Evaluation of Quantity of Fine Particle Aggregates Having Oxygen Atom)

Each of the molded bodies of Examples 1 to 3 and the molded body of Comparative Example 1 was continuously irradiated with light having a wavelength of 440 nm emitted from an LED light source for 1,000 hours. Next, each of the molded bodies was cut using a desktop circular sawing machine (device name: K210, manufactured by HOZAN TOOL INDUSTRIAL CO., LTD.) such that a cross section on the optical path of the emitted light appeared. Next, each of the cut molded bodies was sliced with a microtome to prepare a slice having a thickness of 10 μm. Next, each of the slices was subjected to energy dispersive X-ray spectrometry (EDS) under the following conditions to confirm the fine particle aggregate having an oxygen atom.

### (Analysis Conditions)

Device name: JSM-IT700HR (manufactured by JEOL Ltd.)
Detector: EDS detector, dry SD detector
Device name: EX-7412U4L2Q
Method: Silicon drift type
Detection element area: 30 mm²
Energy resolution: 129 eV or less
Detectable elements: Be to U
Window: Polymer thin film
Cooling method: Electronic cooling (Peltier cooling)
Usable acceleration voltage: 30 kV or less
Digital processor
Maximum throughput: 200 kcps
Interface: RS-232C

Next, each slice was subjected to platinum coating, and the fine particle aggregate was observed using a scanning electron microscope (SEM) under the following conditions. In this case, the number of fine particle aggregates, which had been confirmed to have an oxygen atom by energy dispersive X-ray spectrometry and had a size of 100 nm or more and 5 μm or less, was observed, and then the evaluation was carried out in five stages of A to E.

### (Analysis Conditions)

Device name: JSM-IT700HR (manufactured by JEOL Ltd.)
Signal: SED
Incident voltage: 15.0 kV
WD: 10.0 mm
Magnification: ×1,000
Observation range: 128.0×96.0 μm
Irradiation current number: Srd. 75.0
Scan rotation: 0.0°
Vacuum mode: High Vacuum

In the evaluation, regarding a case where the number of fine particle aggregates, which had been confirmed to have an oxygen atom by energy dispersive X-ray spectrometry and had a size of 100 nm or more and 5 μm or less, a case where the number of fine particle aggregates was 2 or less was evaluated as A, a case where the number of fine particle aggregates was 3 or more and less than 5 evaluated as B, a case where the number of fine particle aggregates was 5 or more and less than 10 was evaluated as C, a case where the number of fine particle aggregates was 10 or more and less than 15 was evaluated as D, and a case where the number of fine particle aggregates was 15 or more was evaluated as E. FIG. 4 summarizes the evaluation results of the quantity of fine particle aggregates having an oxygen atom in Examples 1 to 3 and Comparative Example 1. It is noted that numerical values in parentheses shown in FIG. 4 are actually measured values.

### (Evaluation of Spectral Transmittance at Wavelength of 320 nm)

The spectral transmittance (%) of each of the molded bodies of Examples 1 to 3 and the molded body of Comparative Example 1 at a wavelength of 320 nm in the thickness direction was measured using an ultraviolet-visible spectrophotometer (device name: UV-2600i, manufactured by Shimadzu Corporation). In the measurement, the measurement was carried out by scanning a wavelength of 250 nm to 800 nm with a D2 light source and a W light source. Then, the spectral transmittance (%) at a wavelength of 320 nm was evaluated in five stages of A to E.

In the evaluation, a case where the spectral transmittance at a wavelength of 320 nm was 65% or more and less than 90% was evaluated as A, a case where the spectral transmittance at a wavelength of 320 nm was 60% or more and less than 65% was evaluated as B, a case where the spectral transmittance at a wavelength of 320 nm was 55% or more and less than 60% was evaluated as C, a case where the spectral transmittance at a wavelength of 320 nm was 50% or more and less than 55% was evaluated as D, and a case where the spectral transmittance at a wavelength of 320 nm was less than 50% was evaluated as E. FIG. 4 summarizes the evaluation results of the spectral transmittance in Examples 1 to 3 and Comparative Example 1. It is noted that numerical values in parentheses shown in FIG. 4 are actually measured values.

As is clearly revealed from FIG. 4, according to Examples 1 to 3 in which the molded body has a content of a hydroxy group of 100 ppm or less, it is clearly revealed that the number of fine particle aggregates confirmed in the evaluation of the quantity of the fine particle aggregates having an oxygen atom is less than 10, and the occurrence of white turbidity of the molded body is capable of being suppressed for a long period of time. In addition, it is also clearly revealed that the molded bodies of Examples 1 to 3 make it possible to ensure excellent light transmittance since the spectral transmittance is 50% or more.

In addition, as is clearly revealed from the results of Examples 2 and 3, according to the molded body having a content of a hydroxy group of 50 ppm or less, it is clearly revealed that the number of fine particle aggregates confirmed in the evaluation of the quantity of the fine particle aggregates having an oxygen atom is less than 5, and the occurrence of white turbidity of the molded body is capable of being further suppressed. In addition, it is also clearly revealed that the molded bodies of Examples 2 and 3 makes it possible to ensure more excellent light transmittance since the spectral transmittance is 60% or more.

In addition, as is clearly revealed from the results of Example 3, according to the molded body having a content of a hydroxy group of 40 ppm or less, it is clearly revealed that the number of fine particle aggregates confirmed in the evaluation of the quantity of the fine particle aggregates having an oxygen atom is less than 2, and the occurrence of white turbidity of the molded body is capable of being still further suppressed. In addition, it is also clearly revealed that the molded body of Example 3 makes it possible to ensure still more excellent light transmittance for a long period of time since the spectral transmittance is 75% or more.

On the other hand, according to Comparative Example 1 which is a molded body in which the content of the hydroxy group is 250 ppm or more, it is clearly revealed that the number of fine particle aggregates confirmed in the evaluation of the quantity of the fine particle aggregates having an oxygen atom is 15, and the occurrence of white turbidity of the molded body is not capable of being sufficiently suppressed. In addition, it is clearly revealed that the molded body of Comparative Example 1 has a spectral transmittance of less than 50%, and thus sufficient light transmittance is not capable of being ensured.

As described above, according to the optical lens 12 according to the presently disclosed subject matter, it is possible to suppress the occurrence of white turbidity and ensure light transmittance for a long period of time.

### REFERENCE SIGNS LIST

10: optical unit
11: housing
12: optical lens
13: optical instrument

What is claimed is:

1. An optical lens formed of a polycarbonate resin,
wherein a content of a compound having a hydroxy group derived from polycarbonate, which is contained in the polycarbonate resin, is 0.1 ppm or more and 200 ppm or less, and
a spectral transmittance at a wavelength of 320 nm is 50% or more.

2. The optical lens according to claim 1,
wherein the content of the compound having the hydroxy group is 0.5 ppm or more and 100 ppm or less.

3. The optical lens according to claim 1,
wherein the compound having the hydroxy group includes at least one of compounds represented by General Formulae (1) to (3), respectively,

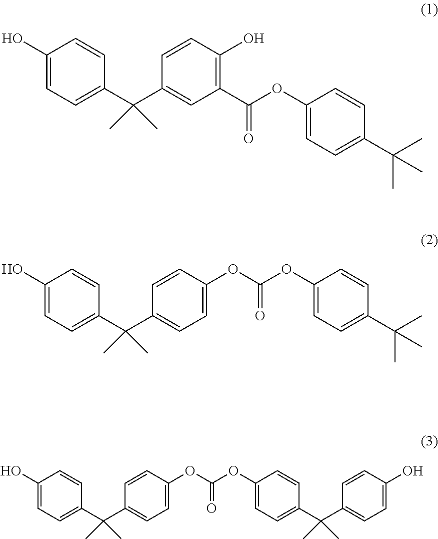

4. The optical lens according to claim 1,
wherein the optical lens is configured to be used for a lens for a lamp of a lamp unit for a vehicle, where the lamp unit has a light emitting device.

5. An optical lens formed of a polycarbonate resin,
wherein, after turning on a light for 1,000 hours, the number of fine particle aggregates which are observed to have a size of 100 nm or more and 5 μm or less in an image obtained by imaging a cross section of the optical lens on an optical path in a thickness direction at a magnification of 1,000 times by using a scanning electron microscope (SEM) and are confirmed to have an oxygen atom by using energy dispersive X-ray spectrometry (EDS) is less than 10.
